(19) United States
(12) Patent Application Publication
(10) Pub. No.: US 2016/0195932 A1
(43) Pub. Date: Jul. 7, 2016

(54) APPARATUS AND METHOD FOR DATA INPUT VIA VIRTUAL CONTROLS WITH HAPTIC FEEDBACK TO SIMULATE KEY FEEL

(71) Applicant: VOLKSWAGEN AG, Wolfsburg (DE)

(72) Inventors: Mark Peter CZELNIK, Wolfsburg (DE); Michael KLAAS, Schwülper (DE); Carsten RIEGER, Lengede (DE)

(21) Appl. No.: 14/987,930

(22) Filed: Jan. 5, 2016

(30) Foreign Application Priority Data
Jan. 5, 2015 (DE) 10 2015 200 038.9

(51) Int. Cl. G06F 3/01; G06F 3/16; G06F 3/041; G06F 3/0488

(52) U.S. Cl. CPC G06F 3/016; G06F 3/04883; G06F 3/04886; G06F 3/167; G06F 3/0414; G06F 2203/04803

(57) ABSTRACT

An apparatus, in particular in a motor vehicle, for inputting a text with haptic feedback, having a touch-sensitive position detection device for determining a two-dimensional actuation element position; at least one actuator element for haptic feedback that is directly or indirectly connected to the touch-sensitive position detection device; and a control device which defines initiation regions of virtual operating elements, wherein a signal is in each case output at the actuator element when the two-dimensional actuation element position accesses and leaves the initiation region of one of the virtual operating elements. Also disclosed is an associated method.

### PRIORITY CLAIM

This patent application claims priority to German Patent Application No. 10 2015 200 038.9, filed 5 Jan. 2015, the disclosure of which is incorporated herein by reference in its entirety.

### SUMMARY

Illustrative embodiments relate to an apparatus and a method for inputting a text via virtual operating elements with haptic feedback, in particular in a motor vehicle.

### BACKGROUND

Modern motor vehicles are equipped with a multiplicity of supplementary functions that go beyond the straightforward conveyance purpose of a motor vehicle. These may be, for example, multimedia systems for receiving radio or reproducing media contents such as music, films or images, communication systems enabling global voice- or text-based communication, or navigation systems that automatically calculate the route on which the journey distance can be covered as much as possible in a time-saving manner and so as to avoid congestion. Furthermore, systems are conceivable which provide the driver or a technician with information about the state of the motor vehicle, such as a so-called on-board computer. What is common to all these systems is that they enable and presuppose an interaction with the vehicle driver or the passengers via various input and output channels.

Alongside voice-based input possibilities, text input on a keyboard is also of importance, for example when inputting street and place names into the navigation system or when inputting a name of a person into the telephone directory.

Illustrative embodiments provide an apparatus and a method for acquiring a text whose operation during acquisition is improved.

### BRIEF DESCRIPTION OF THE DRAWINGS

Disclosed embodiments are explained in greater detail below with reference to the figures, in which:

FIG. 1 shows a schematic illustration of a disclosed embodiment of the apparatus for inputting a text via virtual operating elements with haptic feedback for simulating key haptics;

FIG. 2 shows a front view of a disclosed embodiment of the apparatus in which the touch-sensitive position detection device and the display device are arranged one behind the other;

FIG. 3 shows a perspective rear-side view of the individual elements of a disclosed embodiment of the apparatus;

FIG. 4 shows a schematic illustration of a keyboard formed by a plurality of virtual operating elements, only the initiation regions of the virtual operating elements being shown;

FIG. 5 shows a schematic illustration of the corresponding graphical representation of the plurality of virtual operating elements from FIG. 4;

FIG. 6 shows a schematic illustration of the graphical representation in which some of the virtual operating elements are deactivated;

FIG. 7 shows a schematic illustration of a magnified preview view of a graphical representation of a selected virtual operating element;

FIG. 8 shows a schematic illustration of a typical text input on a keyboard with the aid of seeking haptics;

FIGS. 9a to 9f show a schematic illustration of a sequence of a typical text input on a keyboard with the aid of seeking and key haptics, a schematic measurement signal at the compressive force sensor and output signals at the actuator element and at the loudspeaker;

FIG. 10 shows a schematic flow diagram of the method for inputting a text via virtual operating elements with haptic feedback for simulating key haptics; and

FIG. 11 shows a schematic illustration of a further disclosed embodiment of the apparatus in a human-machine interface.

### DETAILED DESCRIPTION OF THE DISCLOSED EMBODIMENTS

Disclosed embodiments are based on the concept that even in the case of simple operating steps which take place before the final keystroke, such as, for example, seeking and finding the virtual operating element of a specific letter or character on a virtual keyboard, a haptic signal feedback is provided via an actuator element fitted for example to a touch-sensitive detection device for detecting the actuation element position. In this regard, for example, accessing and leaving an individual key can be represented by a vibration or a pulse at the actuator element. In this way, the user recognizes whether he/she is accessing a new key, whether he/she is leaving the key or whether he/she is still on the selected key. Particularly in a motor vehicle, the user can carry out an input without needing to divert his/her gaze from the roadway in the process. This results in an increase not only in convenience during the operation of multimedia and control systems, but also primarily in safety when driving the vehicle.

Disclosed embodiments provide an apparatus for a motor vehicle and a method for a motor vehicle for inputting a text.

### DEFINITIONS

For purposes of the present disclosure, a virtual operating element is the virtual simulation of a physical operating element. The virtual operating element has an initiation region and optionally a graphical representation. The initiation region provided for initiation by means of a pressure gesture may be congruent with the representation region of the graphical representation of the virtual operating element.

For purposes of the present disclosure, a touch-sensitive position detection device is a two-dimensional flat touch surface, on one surface area of which, facing the user, at least one actuation element position can be determined if the actuation element, for example a finger, is in proximity to or on the surface area of the touch surface. Such a touch-sensitive position detection device can be a touchscreen, for example.

For purposes of the present disclosure, an initiation region is a two-dimensional region in which a specific function linked to the region can be initiated in the event of suitable touching actuation. An initiation region is assigned to a virtual operating element.

For purposes of the present disclosure, a keyboard denotes a set of virtual operating elements arranged in relation to one another. A keyboard can be, for example, a virtual simulation of the keys in a QWERTY arrangement as in the case of standard PC keyboards, or a numeric keypad.

Accessing a virtual operating element denotes the instant at which the actuation element position lies within the initiation region assigned to the virtual operating element after it was not detected within the initiation region beforehand.

Leaving a virtual operating element denotes the instant at which the actuation element position lies outside the initiation region assigned to the virtual operating element after it was detected within the initiation region beforehand.

Selecting a virtual operating element denotes the state between accessing and leaving a virtual operating element.

Actuating a virtual operating element denotes the action by means of which the function assigned to the virtual operating element is initiated. Actuating can be effected on a touchscreen for example by the actuation element remaining within the initiation region for a relatively long time, that is to say that a period of remaining lies above a threshold value that is predefined. It is likewise conceivable for actuating to be effected for example as a result of the exceedance of a specific force threshold in the press-on pressure of the actuation element. Detecting a touch position of an actuation element in an initiation region of a virtual operating element does not suffice to bring about an actuation.

In so far as mention is made here of detecting or determining a press-on force or a press-on pressure, this is taken to mean detecting or determining implemented separately from the touch-sensitive position detection. It is effected by means of at least one compressive force sensor embodied in addition to the touch-sensitive position detection device.

In particular, provision is thus made of an apparatus, in particular in a motor vehicle, for inputting a text with haptic feedback, comprising a touch-sensitive position detection device for determining a two-dimensional actuation element position, at least one actuator element for haptic feedback, the at least one actuator element being directly or indirectly connected to the touch-sensitive position detection device, a control device, wherein the control device defines initiation regions of virtual operating elements, and a signal is in each case output at the actuator element when the two-dimensional actuation element position accesses and leaves the initiation region of one of the virtual operating elements.

Furthermore, a method, in particular in a motor vehicle, for inputting a text on a virtual keyboard with haptic feedback is proposed, comprising the following steps: assigning initiation regions to virtual operating elements, detecting an actuation element position, comparing the actuation element position with the initiation regions of the virtual operating elements, wherein a haptic feedback is in each case provided when the actuation element position accesses and leaves the initiation region of one of the virtual operating elements.

The user is provided with a haptic feedback before the actuation of a virtual operating element. It thus becomes possible for the user to sense the virtual operating elements. This seeking haptics allows a virtual operating element sought to be found significantly faster and allows simpler supervision of the selection of the virtual operating element. As a result, the number of erroneous inputs decreases, which in turn results in increased convenience in the operation of multimedia or control systems in motor vehicles. Since a haptic feedback is effected, the vehicle driver furthermore has to divert his/her gaze from the roadway less often. As a result, the driver can monitor events in front of the motor vehicle without interruption with almost undivided attention and can react more rapidly to obstacles or hazards in the vicinity of the motor vehicle. This increases safety for the vehicle driver, the occupants and the other road users.

Disclosed embodiments provide an apparatus having a display device. The virtual operating elements can be represented graphically on the display device. As a result, alongside the haptic feedback, the operator also receives visual information about the initiation region and/or the function linked to the virtual operating element.

The display device can be positioned for example directly behind the touch-sensitive position detection device, such that the haptic feedback when accessing and leaving a virtual operating element corresponds to the visual representation of the virtual operating element. However, it is likewise conceivable, moreover, for the display device or a further display device to be fitted at a different location in the motor vehicle. One possible location might be, for example, the windshield of the vehicle. By way of example, a display projected into the windshield might represent such a display device (so-called head-up displays or reflector sights). During operation, the driver then has both the roadway and the virtual operating element via the display device in the field of view, which signifies an increase in safety since the driver no longer has to divert his/her gaze from the roadway.

Ideally, in at least one disclosed embodiment, the functions linked to the virtual operating elements are represented as graphical representations on the display device. Either letters, numerals or graphics, for example, pictograms, are appropriate in this case. Here it is possible to have recourse to the user's experience if recourse is had to representations which are already known or are customary in general traffic for specific functions which are linked to the virtual operating elements. By way of example, such representations may be letters of the Roman alphabet or graphics such as are typically used in navigation systems, such as the pictogram of a destination flag or a traffic sign for risk of congestion. Operation is significantly simplified by the graphical representation.

In a further disclosed embodiment, the apparatus comprises a loudspeaker, at which an acoustic signal is output simultaneously with the pulse at the actuator element. As a result, the operator is provided with a further sensory feedback alongside the haptic feedback. By way of example, an acoustic sample can be played back which simulates the sound of a keystroke or click. The additional acoustic feedback makes it possible, on account of perception-psychological effects, to reduce the intensity of the haptic feedback without adversely affecting perception. The amplitude of the pulse present at the actuator element can then be reduced, with the result that the actuator element and all other elements connected to the actuator element wear less rapidly. The loudspeaker can be directly or indirectly connected to the apparatus.

The sample can optionally be output via the loudspeakers of a multimedia system. Perception is poorer, however, since the acoustic origin often does not correspond to the actuation element position owing to spatial hearing.

Therefore, in at least one disclosed embodiment, the loudspeaker is situated in direct proximity in or on the apparatus or the touch-sensitive position detection device. A small spacing with respect to the actuation element position results, on the part of the operator, in a logical linking of the acoustic signal to the actuation of the virtual operating element or to the haptic feedback.

At least one disclosed embodiment provides for the virtual operating elements to form a keyboard. In this regard, it is possible to simulate arrangements known to the user, for example, such as a QWERTY keyboard or a numeric keypad. As a result, the user can have recourse to empirical knowledge and employ learned movement patterns when seeking and actuating the virtual operating elements. As a result, the operation of the apparatus is immediately intuitively clear to the user and he/she requires only little familiarization time.

In at least one disclosed embodiment, the apparatus comprises a compressive force sensor, which detects a press-on pressure of an actuation element, for example of a finger, on the touch-sensitive position detection device and feeds a signal, which may be proportional to the press-on pressure, to the control device. As a result, it is possible, alongside the actuation element position on the touch-sensitive position detection device, also to evaluate the press-on pressure as well and to use it for operation. A number of types of compressive force sensors are known to the person skilled in the art, for example embodied as strain gauge, as inductive compressive force sensor or as capacitive compressive force sensor.

By way of example, a function or action linked to a virtual operating element can be initiated by a specific force threshold being exceeded if the actuation element position corresponds precisely to the initiation region of the virtual operating element. Further force thresholds are also conceivable which, as a result of being exceeded or undershot, initiate a function linked to the virtual operating element.

In at least one disclosed embodiment, a signal is output at the actuator element when a specific force threshold is exceeded. This disclosed embodiment makes it possible to simulate the haptics of a physical key. If the operator for example has already accessed a virtual operating element and subsequently increases the press-on pressure of the actuation element, for example a finger, positioned on the virtual operating element, then the operator, in the event of the force threshold being exceeded, obtains a haptic feedback via the actuator element and/or an acoustic feedback via a loudspeaker and the function assigned to the virtual operating element is initiated.

In this case, by way of example, the use of further force thresholds which, when exceeded or undershot, output a signal at the actuator element and/or a signal at the loudspeaker may also be expedient. In this case, for example, simulations of the haptics of a key of a standard PC keyboard or of a physical cell phone keyboard are thus possible. Both patterns are known to the operator and thus engender a recognition effect that facilitates operation. Key haptics which can be selected individually by the operator and which the operator can select according to his/her personal taste are also conceivable.

It should be noted that the impression of actuating a physical key arises primarily as a result of the presence of two haptic feedbacks: one haptic feedback is perceptible when the key is pressed, and another when the key is released (also referred to as snap and back snap). The sensory experience of such a physical key can be simulated by the definition of two different force thresholds which must be exceeded and undershot, respectively, and in the case of which respectively a signal is output at the actuator element and/or a signal is output simultaneously at a loudspeaker.

Optionally, the haptic feedbacks initiated by a first, a second and/or further force thresholds being exceeded and/or undershot differ from one another and from the haptic feedbacks which are provided in the event of the initiation region of a virtual operating element being accessed and/or left.

Likewise, the haptic feedbacks which are provided in the event of the initiation region of a virtual operating element being accessed and/or left differ from one another. This assists in differentiating between accessing and leaving a key.

In at least one disclosed embodiment, when a virtual operating element is selected, a further haptic feedback is effected, which differs from the other haptic feedbacks. By way of example, a selection could be accompanied by a continuous vibration by the actuator element which for example has a lower intensity than the other haptic feedbacks and is only ended if the virtual operating element has been actuated or left.

In a further disclosed embodiment, a graphical representation of a virtual operating element is represented in a magnified fashion on a display device when the virtual operating element is accessed. This affords the possibility, alongside a haptic and an optional acoustic feedback, of additionally providing a visual feedback as well. Both a magnified representation in a display device arranged directly behind the touch-sensitive position detection device and a magnified representation in a display device situated in the region of the windshield of the motor vehicle are conceivable here. In this regard, by way of example, letters of a keyboard or pictograms associated with the virtual operating element can be represented in a magnified fashion during access to facilitate seeking.

Ideally, in at least one disclosed embodiment, a content of the graphical representation or a function or action which is linked to a virtual operating element is output as text read aloud on a loudspeaker. By way of example, individual letters of a keyboard can thus be read aloud. It is also conceivable to read aloud a semantic content of a pictogram linked to the virtual operating element. In this way, the user also obtains a further feedback regarding the virtual operating element currently being handled by the user.

In a further disclosed embodiment, a portion of the virtual operating elements is deactivated in a context-based fashion. If a display device that images the virtual operating elements is present, then the deactivated virtual operating elements are identified as deactivated. By way of example, letters can be masked out or represented in a different color. A function linked to a deactivated virtual operating element can then no longer be selected and actuated. In this regard, by way of example, it is possible to deactivate specific letters when inputting the destination location if it emerges from the context of the sequence of letters input previously that a destination location having such a name does not exist. The risk of an erroneous input is significantly reduced by the context-dependent deactivation of the virtual operating elements. Optionally, no haptic feedback is generated in the event of deactivated virtual operating elements being accessed and left.

In other disclosed embodiments, a feedback that deviates from the feedback that is generated in the case of active virtual operating elements can be effected in the event of deactivated virtual operating elements being accessed and left. Optionally, the feedback in the event of accessing and leaving is weaker in the case of deactivated virtual operating elements than in the case of active virtual operating elements.

In at least one disclosed embodiment, the haptic feedbacks are embodied differently in the case of accessing and leaving. By way of example, the feedback provided in the event of accessing is stronger than that provided in the event of leaving. As a result, the operator recognizes whether he/she is accessing or leaving a virtual operating element.

In at least one disclosed embodiment, the haptic feedback is embodied in a pulselike fashion. By way of example, in the event of accessing and/or leaving virtual operating elements, an individual pulse or a multiplicity of pulses is/are output at the actuator element, wherein post-pulse oscillation of the touch-sensitive position detection device may be kept small. In other words, the touch surface may be deflected once and then returns to an initial position. If appropriate, there are one or more highly damped post-pulse oscillations or overshoots.

In at least one disclosed embodiment, the apparatus comprises an interface, at which actuation element positions detected by the touch-sensitive position detection device and/or a value detected by the compressive force sensor, the value being proportional to the press-on compressive force, and/or further data are output. The interface can be for example a standardized interface such as the CAN bus widely used in motor vehicles, but it can also be embodied differently.

In at least one disclosed embodiment, provision is made, in particular, for the apparatus to be designed for integration into an interior of a motor vehicle, in particular into a cockpit of the motor vehicle, or into a headrest, a roof liner or a center console in the rear region of the motor vehicle.

All embodiments described for a motor vehicle can also be realized in further embodiments without the motor vehicle. In this regard, the disclosed input method and the disclosed apparatus can be embodied in all fields in which a machine-human interaction takes place at a human-machine interface, for example in a computer, a laptop, a tablet computer, a smartphone, an interactive table, an automatic ticket machine, an information pillar, an interactive control apparatus, in control stations and in computers which assist blind persons.

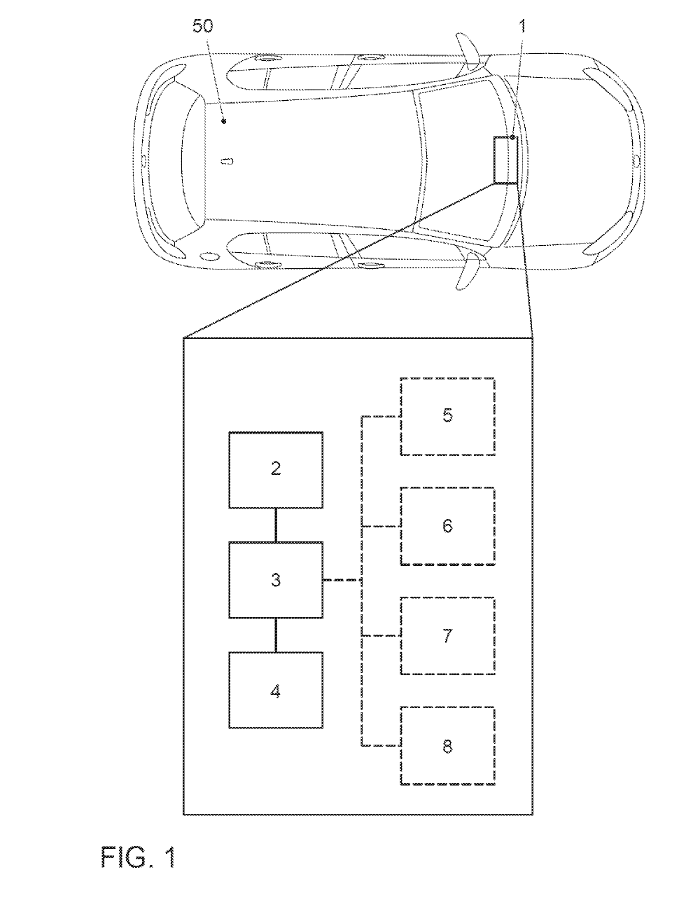

FIG. 1 illustrates a schematic illustration of at least one disclosed embodiment of the apparatus 1. In a motor vehicle 50, an apparatus 1 for inputting a text via virtual operating elements with haptic feedback for simulating key haptics is situated in the passenger compartment. The apparatus 1 comprises at least one touch-sensitive position detection device 2, at least one actuator element 3 and a control device 4. The one touch-sensitive position detection device 2 and the actuator element 3 are controlled via the control device 4. The control device 4 defines the initiation regions of virtual operating elements on a two-dimensional area. To initiate functions, which can involve for example inputting a text for the place indication in a navigation system or inputting a name or a number in the telephone directory, the operator positions an actuation element, for example his/her finger, on the touch-sensitive position detection device 2, which detects the actuation element position and transfers it to the control device 4. The control device 4 then determines whether the user is currently accessing or leaving a virtual operating element and then correspondingly instigates the outputting of a pulse at the actuator element 3. Since the actuator element 3 is directly or indirectly connected to the touch-sensitive position detection device 2, the user experiences a haptic feedback.

Optionally, the control device 4 is embodied as a central computer or microcontroller and its functions are carried out in terms of software.

Optionally, the apparatus 1 can comprise a display device 5, which represents graphical representations of the virtual operating elements. Ideally, the display device 5 is positioned behind the touch-sensitive position detection device 2 such that the graphic representation associated with a virtual operating element corresponds to the region of the virtual operating element on the touch-sensitive position detection device 2. The display device 5 is driven by the control device 4.

A compressive force sensor 6 fitted to the apparatus 1 directly or indirectly is likewise optional. Ideally, the compressive force sensor 6 is fitted to the touch-sensitive position detection device 2 such that the press-on pressure of an actuation element, for example the press-on pressure of a finger of the operator, can be detected. The compressive force sensor 6 detects the press-on pressure of an operator and forwards a value proportional to the press-on compressive force to the control device 4. In the event of one or a plurality of force thresholds being exceeded or undershot at the compressive force sensor 6, a signal can be output at the actuator element 3 by means of the control device 4. Functions or actions which are linked to the pressed virtual operating element can likewise be initiated as a result of a force threshold being exceeded or undershot.

A further disclosed embodiment includes is a loudspeaker 7 positioned in or on the apparatus 1. If a haptic feedback by means of the actuator element 3 occurs in the course of the operation of the apparatus 1, then a signal can simultaneously be output on the loudspeaker 7 by the control device 4. The signal can be for example a sample that simulates the sound of a keystroke.

Optionally, the apparatus 1 can comprise an interface 8, which outputs the data collected and processed by the control device 4 for further processing. Such an interface 8 can be for example the CAN bus widely used in motor vehicles, but it can also be embodied differently.

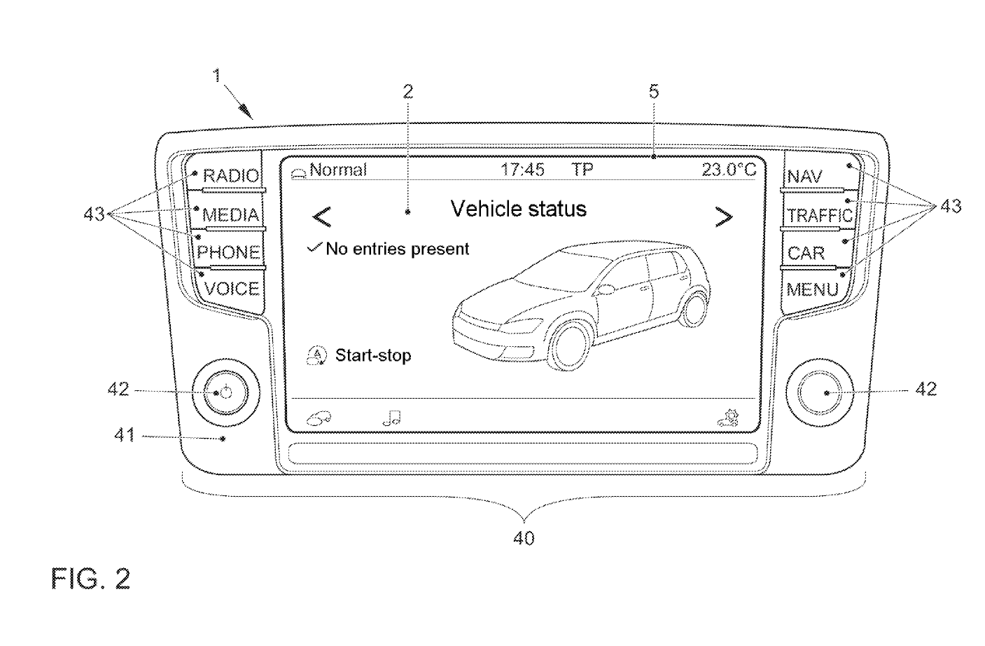

FIG. 2 schematically depicts a disclosed embodiment of the apparatus 1 in front view. In this case, the apparatus 1 is integrated into a multimedia display/operating apparatus 40 such as is customary nowadays in mid-range and top-of-the-range motor vehicles. The front panel 41, the touch-sensitive position detection device 2 and the display device 5 are visible in the front view. The control device 4 and the actuator element 5 are not visible in the front view. Furthermore, the display/operating apparatus 40 comprises two rotary push encoders 42 and a plurality of physically embodied buttons 42.

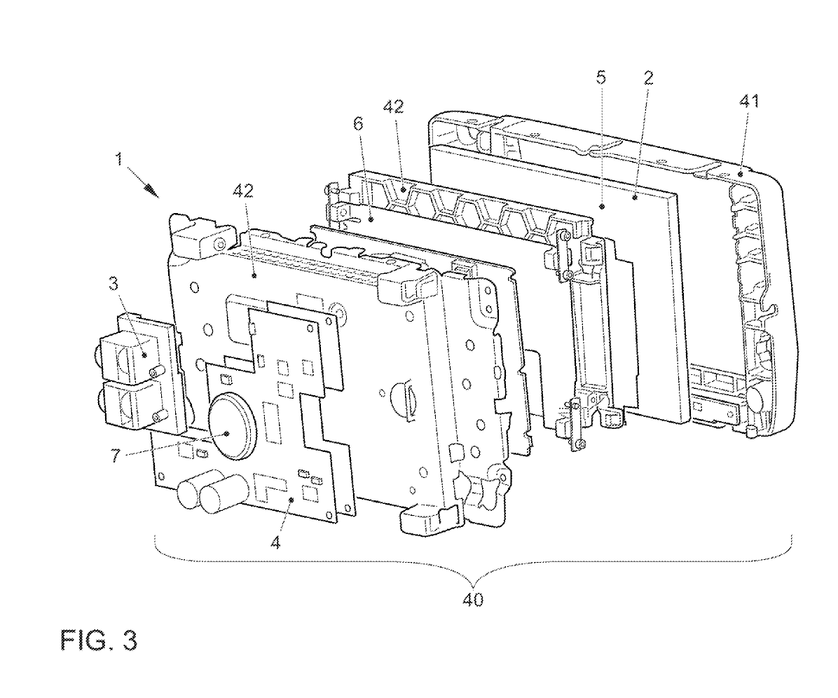

FIG. 3 shows a perspective rear-side view of the individual features of a disclosed embodiment of the apparatus 1. Situated behind a front panel 41 of a multimedia display/operating apparatus 40 there is a touch-sensitive position detection device 2 and behind that a display device 5. The touch-sensitive position detection device 2 and the display device 5 can also be embodied in a manner combined in a single component as a so-called touchscreen. A compressive force sensor 6 is situated behind the display device 5. Situated at the rear side of the display/operating apparatus 40 there is a control device 4 and an actuator element 3 connected directly or indirectly to the housing. The signal output at the actuator element 3 by the control device 4 in the event of a virtual operating element being accessed, left or actuated propagates via the housing of the display/operating apparatus 40 as far as the touch-sensitive position detection device 2 and is thus transmitted to the actuation element, for example to the finger of the operator. In this case, the actuator element 3 can be deflected either parallel or perpendicular to the plane of the display device 5. A parallel deflection has the advantage that the touch-sensitive position detection device 2 can be embodied more stiffly, which gives the operator the impression of a higher quality of the display/operating apparatus 40. Furthermore, in the case of parallel deflection, the distance between the touch-sensitive position detection device 2 and the front panel 41 or other elements of the display/operating apparatus 40 can be smaller, thus resulting in less contamination of the interior of the display/operating apparatus 40 by dust, etc. By contrast, a perpendicular deflection of the actuator element 3 has the advantage that the operator perceives the signal, for example via his/her finger, more intensely and the signal at the actuator element 3 can be manifested to a smaller degree as a result.

A loudspeaker 7 is situated at the control device 4. The positioning of the loudspeaker 7 in proximity to the touch-sensitive position detection device 2 and the display device 5 has the advantage that the acoustic signal is associated by the operator with the location of the display/operating apparatus 40 in the motor vehicle. This arrangement motivated by perception-psychological considerations increases the perception of the feedback on the part of the operator.

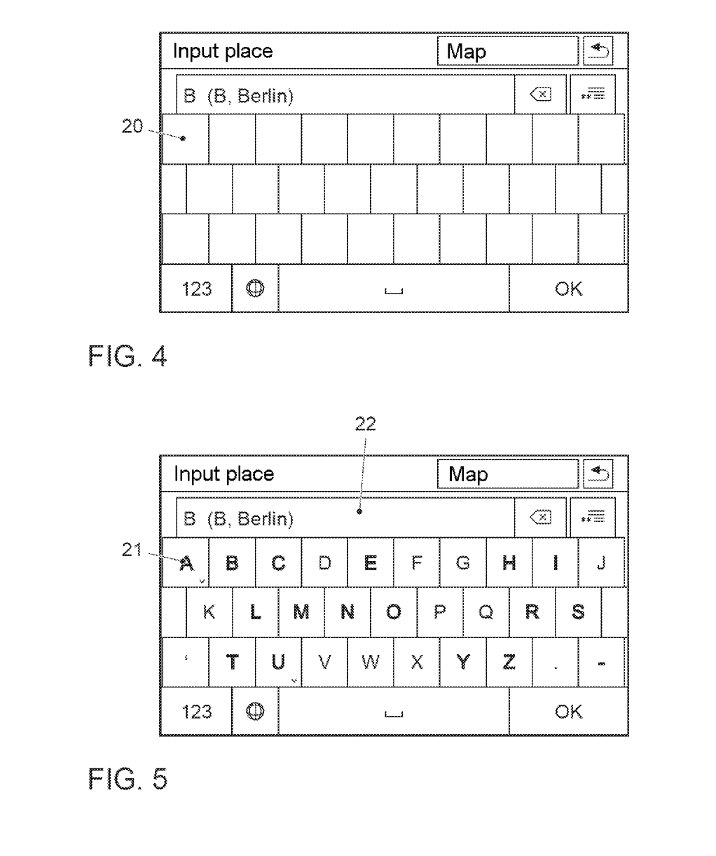

FIG. 4 shows a schematic illustration of virtual operating elements 20. Only the initiation regions linked to the virtual operating elements are illustrated here as closed rectangles.

FIG. 5 shows the graphical representations 21 of the virtual operating elements that correspond to FIG. 4. The virtual operating elements and the graphical representations 21 can form a keyboard, for example, on which the Roman alphabet is depicted in its order. However, other arrangements and graphical representations 21 are also conceivable. An input field 22 is also visible in FIG. 5, in which input field a text can be input with the aid of the keyboard.

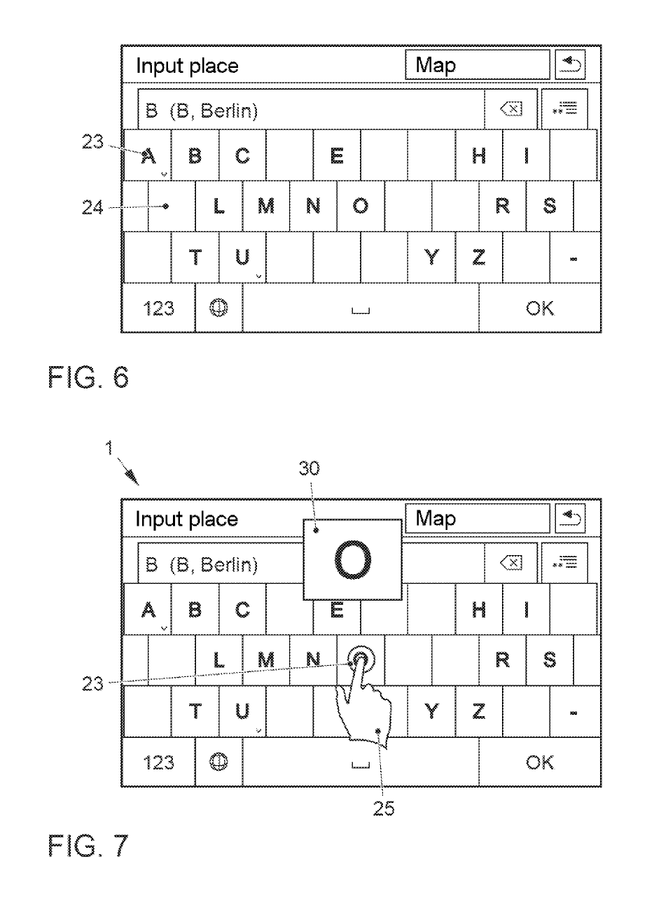

FIG. 6 shows a graphical representation 21 of the virtual operating elements similar to that in FIG. 5. However, the graphical representations are subdivided into two categories. Depending on the context, that is to say for example a text already input and the possible letters that follow, some virtual operating elements are activated or deactivated. Correspondingly, the graphical representation of an active virtual operating element 23 and the graphical representation of a deactivated virtual operating element 24 differ. By way of example, the colors of the letters on the graphical representations can differ. In this regard, an active virtual operating element 23 can have the letter color white, for example, whereas a deactivated virtual operating element 24 has the letter color gray.

FIG. 7 schematically shows a disclosed embodiment of the preview view 30 of the graphical representation of an active virtual operating element 23. If the actuation element, for example the finger of the operator 25, is situated on an active virtual operating element 23, here for example the letter “O”, then the graphical representation is represented in a magnified fashion, for example. The operator is thus additionally provided with a visual feedback. If the actuation element, here the finger of the operator 25, is situated for example on a deactivated virtual operating element 24, then no preview view 30 is depicted. However, other preview views 30, both of active 23 and of deactivated 24 virtual operating elements, are also conceivable.

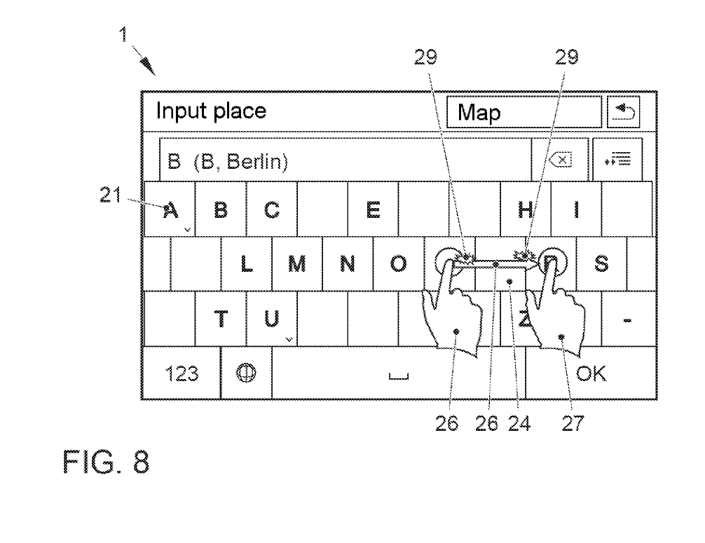

The functioning of the seeking haptics is elucidated schematically in FIG. 8. The graphical representation 21 of the virtual operating elements can be seen. The actuation element, here for example the finger of the operator 25, is situated on a first position 26 within the initiation region of an active virtual operating element 23, here for example a key having a letter of the Roman alphabet. By means of actuation, for example by means of an increase in the press-on pressure above an initiation threshold value or alternatively by means of staying at the touch position for a time duration above an initiation threshold duration, of the active virtual operating element 23, the letter can be input. Optionally, a haptic and/or acoustic feedback is effected in the event of actuation, the feedback being different from the haptic and/or acoustic feedbacks in the event of virtual operating elements being accessed and left. After the inputting or non-inputting of the letter, the finger of the operator 25 leaves the first position 26. In the event of the initiation region of the active virtual operating element 23 being left, a haptic feedback 29 is effected by the outputting of a signal at the actuator element and, optionally, a simultaneous acoustic feedback 29 is effected by the outputting of a signal at the loudspeaker. The finger of the operator 25 then follows a trajectory 28, wherein the operator drives the next virtual operating element for inputting. To facilitate seeking for the finger of the operator 25, in the event of accessing a nearest active virtual operating element 23, the initiation region of which lies at a second position 27, once again a haptic and optionally an acoustic feedback 29 is effected to indicate to the operator the accessing of the nearest active virtual operating element 23. Sweeping over deactivated virtual operating elements 28 does not lead to haptic and/or acoustic feedback.

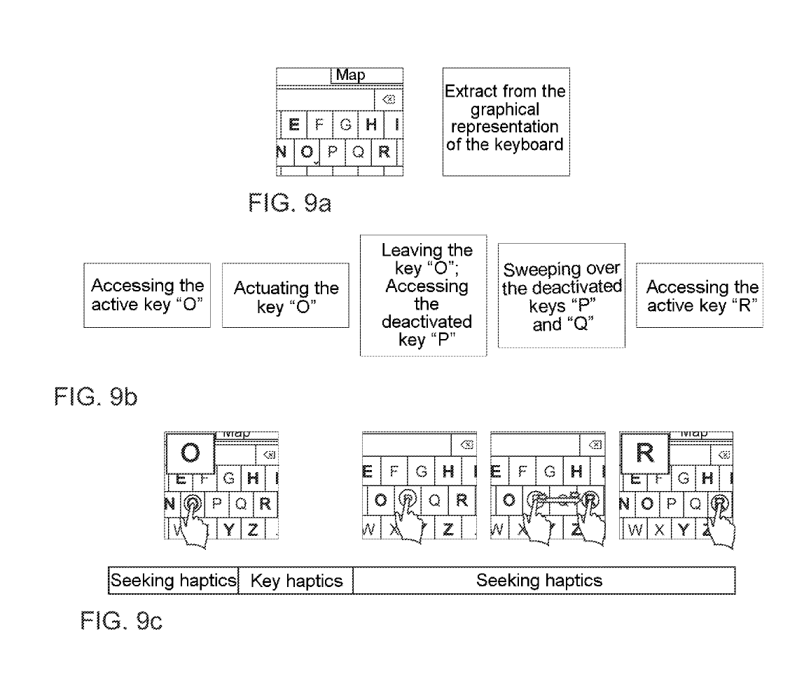

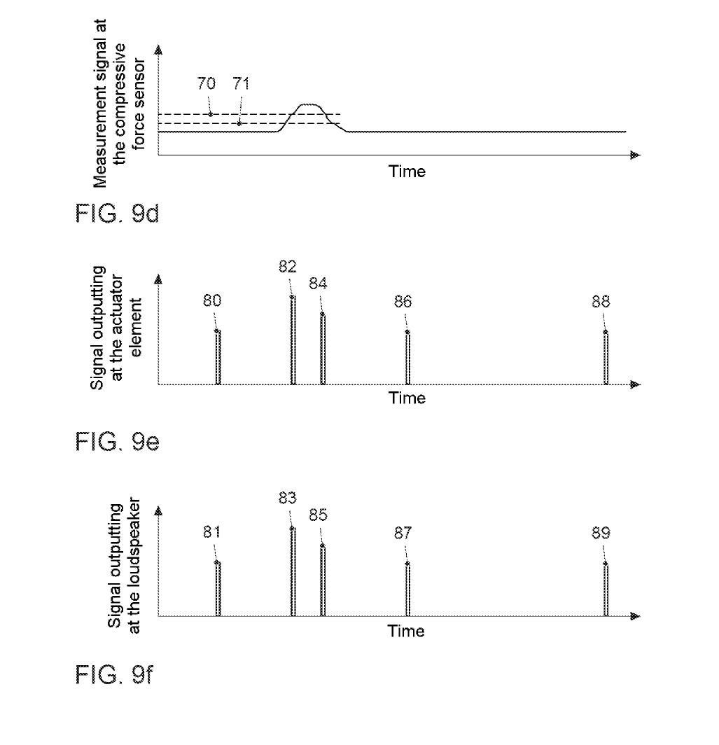

FIGS. 9a to 9f schematically illustrate the sequence of a typical text input. Both the seeking haptics when seeking a specific virtual operating element and the key haptics when actuating a virtual operating element are illustrated here. FIG. 9a shows the extract under consideration from the graphical representation of a portion of the virtual operating elements which here represent an alphabetic keyboard. FIG. 9b describes the individual steps carried out by the operator in the course of time using an actuation element, here for example his/her finger, to seek and actuate a virtual operating element. FIG. 9c schematically shows the operator's actions on the graphical representation or the touch-sensitive position detection device. FIG. 9d shows the profile of the measurement signal at the compressive force sensor over time, both in the mode of the seeking haptics and the mode of the key haptics. FIG. 9e and FIG. 9f show the profile of the signals which are output at the actuator element and at an optional loudspeaker.

In the first step, the operator accesses for example an active virtual operating element representing the letter “O”. In the event of accessing, in the mode of the seeking haptics, a haptic feedback is effected by the outputting of a signal at the actuator element, here a simple pulse 80. Optionally, the haptic feedback can be supported by the simultaneous outputting of a pulse 81 at the loudspeaker. The operator then decides to input the letter “O” and therefore increases the pressure on the touch-sensitive position detection device to actuate the virtual operating element regarding the letter “O”. The rising pressure is detected by the compressive force sensor and, in the mode of key haptics, a haptic 82 and optionally an acoustic 83 feedback is effected in the event of a first force threshold 70 being exceeded. As a result of the first force threshold 70 being exceeded, a function is likewise initiated here, here for example the inputting of the letter “O” into the input field. In the event of a second force threshold 71 subsequently being undershot, still in the mode of key haptics, a further haptic 84 and optionally acoustic 85 feedback is effected by the outputting of a signal at the actuator element and at the loudspeaker. In this case, the signals in the mode of key haptics have for example, a greater amplitude than those in the mode of seeking haptics. In this regard, the keystroke can be made clear to the operator. After the keystroke and after the second force threshold 71 has been undershot, the operator leaves the virtual operating element of the letter “O” toward the right-hand side. In the event of leaving, in the mode of seeking haptics, a pulse 86 is output at the actuator element and, optionally, a pulse 87 is output at the loudspeaker to indicate leaving to the operator. Afterward, the operator accesses a deactivated virtual operating element, here for example a key for the letter “P”. Since the key is associated with a deactivated virtual operating element, no haptic or acoustic feedback is provided. Afterward, the operator once again sweeps over a deactivated virtual operating element, for example a key for the letter “Q”. Once again no feedback whatsoever is provided. It is only upon accessing the nearest active virtual operating element, here for example the letter “R”, that the operator again receives a haptic 88, and optionally an acoustic 89, feedback by means of a signal at the actuator element. Consequently, at every moment it is clear to the operator whether or not he/she is on an active virtual operating element.

The signals output at the actuator element and at the loudspeaker can be arbitrary signals and are illustrated here as simple pulses 80-89 merely for the sake of schematic clarification. It is conceivable, for example to output at the loudspeaker a sound sample that simulates the sound of a physical key.

More complex signals at the actuator element are likewise conceivable: in a manner similar to a sound sample, for example, the force characteristic of a physically embodied key could be determined and subsequently simulated by the signal at the actuator element. Also conceivable are mathematical functions which use the context of the virtual operating elements, the actuation element position, here of the finger of the operator, and/or the press-on pressure of the actuation element and/or further parameters as input parameters for calculating an output signal for the actuator element and optionally the loudspeaker.

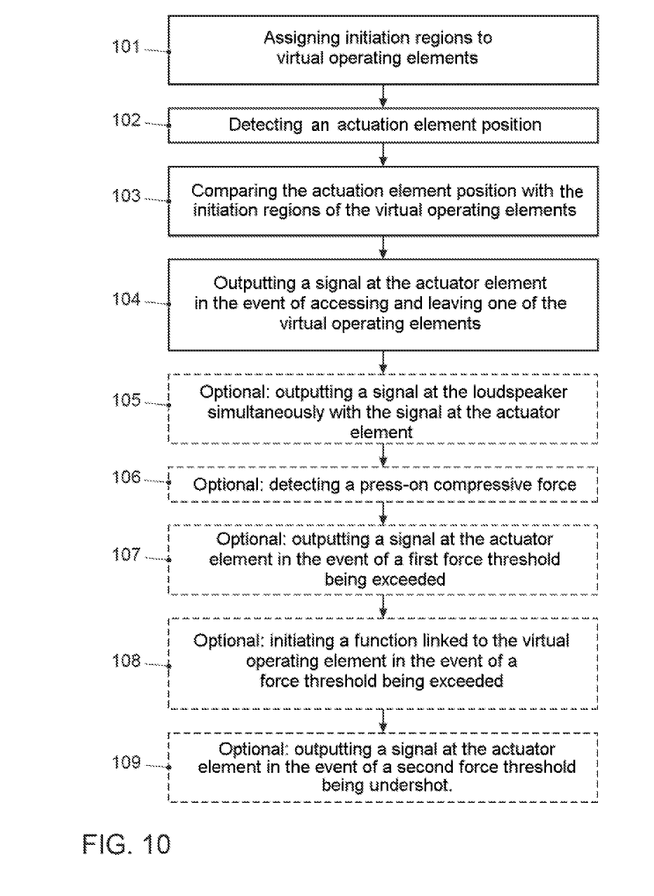

FIG. 10 shows a schematic flow diagram of the method for inputting a text via virtual operating elements with haptic feedback in seeking haptics and optional key haptics. In the first step, initiation regions are assigned 101 to the virtual operating elements. Afterward, an actuation element position of an operator is detected 102 by means of a touch-sensitive position detection device. The detected actuation element position is compared 103 with the initiation regions of the virtual operating elements. In the event of a virtual operating element being accessed and left, a signal is output 104 at the actuator element. Optionally, a further signal can simultaneously be output 105 at a loudspeaker. Likewise optionally, a press-on compressive force can simultaneously be detected 106 by means of a compressive force sensor. In the event of a first force threshold being exceeded, this results in the outputting 107 of a further signal at the actuator element and optionally a further signal at the loudspeaker. Optionally, as a result of the first force threshold being exceeded, a function linked to the virtual operating element, for example the inputting of a letter, can be initiated 108. Furthermore, optionally, in the event of a second force threshold being undershot, this results in the outputting 109 of a further signal at the actuator element and optionally a further signal at the loudspeaker.

The feedback during the key seeking makes it easier for the operator to find the virtual operating element sought. As a result of the detection of the press-on compressive force and the haptic and/or acoustic feedbacks linked to the two force thresholds, it is furthermore possible to simulate the haptic and acoustic perception during the actuation of a physically embodied key. The operator thus obtains more complete information about his/her actions, which improves the inputting during the journey and reduces erroneous operations.

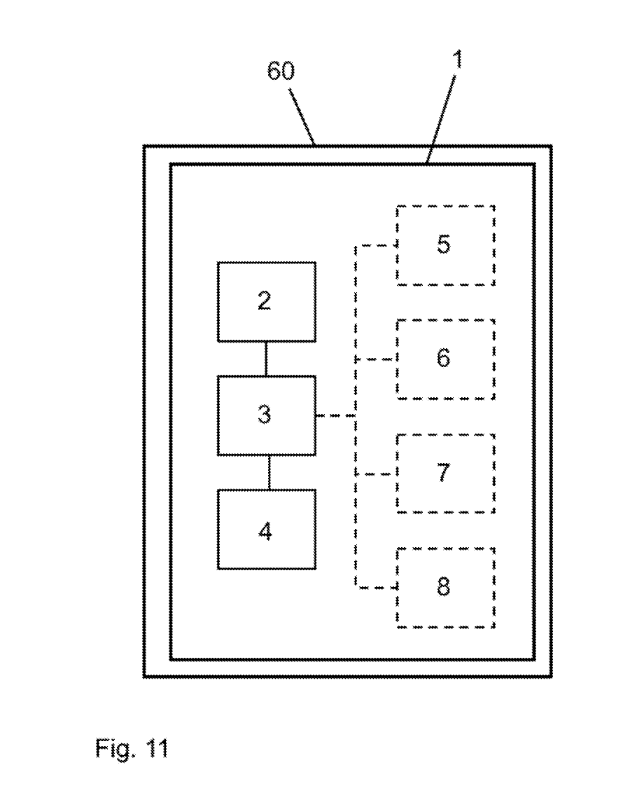

FIG. 11 illustrates a schematic illustration of a further disclosed embodiment of the apparatus 1 for inputting a text via virtual operating elements with haptic feedback for simulating key haptics in a human-machine interface 60.

A human-machine interface 60 can be, for example, a computer, a laptop, a tablet computer, a smartphone, an interactive table, an automatic ticket machine, an information pillar, an interactive control apparatus in control stations, domestic appliances or consumer electronics or a computer which assists blind persons.

The apparatus 1 comprises at least one touch-sensitive position detection device 2, at least one actuator element 3 and a control device 4. The one touch-sensitive position detection device 2 and the actuator element 3 are controlled via the control device 4. The control device 4 defines the initiation regions of virtual operating elements on a two-dimensional area. To initiate functions, which can involve for example inputting a text for a bank transfer, a name, a search term or other data, the operator positions an actuation element, for example his/her finger, on the touch-sensitive position detection device 2, which detects the actuation element position and transfers it to the control device 4. The control device 4 then determines whether the user is currently accessing or leaving a virtual operating element and then correspondingly instigates the outputting of a pulse at the actuator element 3. Since the actuator element 3 is directly or indirectly connected to the touch-sensitive position detection device 2, the user experiences a haptic feedback.

Optionally, the control device 4 is embodied as a central computer or microcontroller and its functions are carried out in terms of software.

Optionally, the apparatus 1 can comprise a display device 5, which represents graphical representations of the virtual operating elements. Ideally, the display device 5 is positioned behind the touch-sensitive position detection device 2 such that the graphical representation associated with a virtual operating element corresponds to the region of the virtual operating element on the touch-sensitive position detection device 2. The display device 5 is driven by the control device 4.

A compressive force sensor 6 fitted to the apparatus 1 directly or indirectly is likewise optional. Ideally, the compressive force sensor 6 is fitted to the touch-sensitive position detection device 2 such that the press-on pressure of an actuation element, for example the press-on pressure of a finger of the operator, can be detected. The compressive force sensor 6 detects the press-on pressure of an operator and forwards a value proportional to the press-on compressive force to the control device 4. In the event of one or a plurality of force thresholds being exceeded or undershot at the compressive force sensor 6, a signal can be output at the actuator element 3 by means of the control device 4. Functions or actions which are linked to the pressed virtual operating element can likewise be initiated as a result of a force threshold being exceeded or undershot.

A further disclosed embodiment includes a loudspeaker 7 positioned in or on the apparatus 1. If a haptic feedback by means of the actuator element 3 occurs in the course of the operation of the apparatus 1, then a signal can simultaneously be output on the loudspeaker 7 by the control device 4. The signal can be for example a sample that simulates the sound of a keystroke.

Optionally, the apparatus 1 can comprise an interface 8, which outputs the data collected and processed by the control device 4 for further processing. Such an interface 8 can be connected for example to a bus system, a network or the Internet. However, the interface 8 can also be embodied as a virtual interface.

Modern motor vehicles are equipped with a multiplicity of supplementary functions that go beyond the straightforward conveyance purpose of a motor vehicle. These may be, for example, multimedia systems for receiving radio or reproducing media contents such as music, films or images, communication systems enabling global voice- or text-based communication, or navigation systems that automatically calculate the route on which the journey distance can be covered as much as possible in a time-saving manner and so as to avoid congestion. Furthermore, systems are conceivable which provide the driver or a technician with information about the state of the motor vehicle, such as a so-called on-board computer. What is common to all these systems is that they enable and presuppose an interaction with the vehicle driver or the passengers via various input and output channels.

Alongside voice-based input possibilities, text input on a keyboard is also of importance, for example when inputting street and place names into the navigation system or when inputting a name of a person into the telephone directory.

The prior art discloses a number of variants as to how a text can be input. Alongside the real keyboard, which is less widely used in vehicles and in which a physically embodied key is assigned to each letter or to each numeral, virtually simulated keyboards are primarily found, the keys of which can be individually selected and actuated either directly via a touch-sensitive display (touchscreen) or via a rotary push encoder. So that, after pressing a key, the user is provided with a feedback concerning the actuation of a key, both acoustic and haptic feedbacks are customary. By way of example, after each keystroke, an acoustic signal can indicate and confirm the keystroke to the user. In this case, a haptic feedback can be effected, for example, a vibration of the touch-sensitive display. The vibration is usually brought about with the aid of actuators fitted to the housing. The acoustic feedback is output via the multimedia system of the vehicle.

Prior art disclosures provide feedback concerning the keystroke as soon as the key has been pressed; the operation of the virtual keyboard otherwise offers no haptic feedback at all. This is unfavorable, particularly for the vehicle driver when driving, since the driver has to visually seek and find each key, which is made more difficult by a freely swinging arm, vibrations and roadway unevennesses and repeatedly necessitates diverting the gaze from the roadway. Diverting the gaze has an adverse effect on safety when driving the motor vehicle.

Disclosed embodiments provide a virtual keyboard which improves operation when acquiring a text. At the same time, the ease of operation that resulted from the introduction of the touch-sensitive input is intended to be maintained.

Disclosed embodiments provide an apparatus and a method for acquiring a text whose operation during acquisition is improved.

### LIST OF REFERENCE SIGNS

1 Apparatus
2 Touch-sensitive position detection device
3 Actuator element
4 Control device
5 Display device
6 Compressive force sensor
7 Loudspeaker
8 Interface
20 Virtual operating element
21 Graphical representation
22 Input field
23 Active virtual operating element
24 Deactivated virtual operating element
25 Finger of the operator
26 First position
27 Second position
28 Trajectory of the finger
29 Feedback
30 Preview view
40 Display/operating apparatus
41 Front panel
42 Rotary push encoder
43 Physically embodied key
50 Motor vehicle
60 Human-machine interface
70 First force threshold
71 Second force threshold
80-89 Feedbacks
101-108 Method steps

1. An apparatus in a motor vehicle, for inputting a text with haptic feedback, the apparatus comprising:
a touch-sensitive position detection device for determining a two-dimensional actuation element position;
at least one actuator element for haptic feedback, said at least one actuator element being directly or indirectly connected to the touch-sensitive position detection device; and
a control device;
wherein the control device defines initiation regions of virtual operating elements, and a signal is in each case output at the actuator element when the two-dimensional actuation element position accesses and leaves the initiation region of one of the virtual operating elements.

2. The apparatus of claim 1, further comprising a display device.

3. The apparatus of claim 1, wherein, simultaneously with the pulse at the actuator element, an acoustic signal is output at a loudspeaker.

4. The apparatus of claim 1, wherein the virtual operating elements form a keyboard.

5. The apparatus of claim 1, wherein the apparatus comprises a compressive force sensor, wherein the compressive force sensor detects a press-on pressure of an actuation element on the touch-sensitive position detection device and feeds a value corresponding to the press-on pressure to the control device.

6. The apparatus of claim 1, wherein the exceedance of a force threshold at the compressive force sensor is used for actuating the virtual operating element which lies in the initiation region that precisely corresponds to the actuation element position.

7. The apparatus of claim 1, wherein a signal is output at the actuator element as a result of the exceedance of a force threshold at the compressive force sensor.

8. The apparatus of claim 1, wherein the virtual operating elements are represented as a graphical representation on the display device.

9. The apparatus of claim 1, wherein when the two-dimensional actuation element position accesses and leaves the initiation regions of the virtual operating elements, the content of the virtual operating elements is represented in a magnified fashion on the display device.

10. The apparatus of claim 1, wherein, when the two-dimensional actuation element position accesses and leaves the initiation region of one of the virtual operating elements, the content of the virtual operating element is output as text read aloud at the loudspeaker.

11. The apparatus of claim 1, wherein a portion of the virtual operating elements is deactivated in a context-based fashion and is correspondingly identified in a representation on the display device.

12. The apparatus of claim 1, wherein the control device comprises an interface, which outputs the values detected by the touch-sensitive position detection device and the compressive force sensor and/or further data.

13. The apparatus of claim 1, wherein a signal proportional to the press-on pressure is output at the loudspeaker.

14. A method, in particular in a motor vehicle, for inputting a text on a virtual keyboard with haptic feedback, the method comprising:
assigning initiation regions to virtual operating elements;
detecting an actuation element position;
comparing the actuation element position with the initiation regions of the virtual operating elements;
wherein a haptic feedback is in each case provided when the actuation element position accesses and leaves the initiation region of one of the virtual operating elements.

15. The method of claim 14, wherein a press-on compressive force is also detected alongside the actuation element position.

16. The method of claim 15, wherein a haptic feedback is provided when a force threshold of the press-on compressive force is exceeded.

17. The method of claim 15, wherein a function linked to the virtual operating element in whose initiation region the actuation element position is currently situated is initiated when a further force threshold of the press-on compressive force is exceeded.

18. The method of claim 14, wherein an acoustic feedback is effected simultaneously with the haptic feedback.

19. The method of claim 15, wherein a haptic feedback is provided when a force threshold is undershot.

20. The method of claim 15, wherein an acoustic feedback is additionally provided when the force threshold is undershot.

21. The method of claim 14, wherein the haptic feedbacks are embodied differently in the case of accessing and leaving.

22. The method of claim 14, wherein the haptic feedback is embodied in a pulselike fashion.

23. An apparatus for inputting a text with haptic feedback, the apparatus comprising:
a touch-sensitive position detection device for determining a two-dimensional actuation element position;
at least one actuator element for haptic feedback, said at least one actuator element is directly or indirectly connected to the touch-sensitive position detection device; and
a control device;
wherein the control device defines initiation regions of virtual operating elements, and a signal is in each case output at the actuator element when the two-dimensional actuation element position accesses and leaves the initiation region of one of the virtual operating elements.

24. A method for inputting a text on a virtual keyboard with haptic feedback, the method comprising:
assigning initiation regions to virtual operating elements;
detecting an actuation element position; and
comparing the actuation element position with the initiation regions of the virtual operating elements;
wherein a haptic feedback is in each case provided when the actuation element position accesses and leaves the initiation region of one of the virtual operating elements.
